(19) United States
(12) Patent Application Publication
(10) Pub. No.: US 2007/0274975 A1
(43) Pub. Date: Nov. 29, 2007

(54) Method for controlling harmful organisms in Bt maize crops

(75) Inventor: Manfred Kern, Lorzweiler (DE)

Correspondence Address: BUCHANAN, INGERSOLL & ROONEY PC, POST OFFICE BOX 1404, ALEXANDRIA, VA, 22313-1404, US

(73) Assignee: Bayer CropScience GmbH, Frankfurt (DE)

(21) Appl. No.: 11/889,032

(22) Filed: Aug. 8, 2007

Related U.S. Application Data
(62) Division of application No. 10/451,221, filed on Sep. 26, 2003, now abandoned.

(30) Foreign Application Priority Data
Dec. 28, 2000 (DE) 10065395.2

(51) Int. Cl. A01N 63/00; A01N 43/24; A01N 43/40; A01N 43/56; A01N 47/28; A01P 17/00; A01P 7/04; A01N 53/02; A01N 57/00; A01N 57/16; A01N 57/26

(52) U.S. Cl. 424/93.461; 424/93.6; 514/134; 514/137; 514/340; 514/341; 514/407; 514/431; 514/531; 514/535; 514/594; 514/75; 514/81; 514/89

(57) ABSTRACT

Method for controlling harmful organisms in genetically modified maize plants containing a gene derived from Bacillus thuringiensis, said gene encoding and expressing protein with an insecticidal action, wherein an insecticidally active quantity of one or more compounds from the groups (a) to (f) specified in detail in the description is applied to the plants, their seeds or propagation material and/or the area in which they are cultivated: a) insecticidal organophosphorus compounds b) pyrethroids c) insecticidal carbamates d) biopesticides e) insecticidal growth regulators f) others. The inventive method makes possible a reduced application rate of crop protectants which act synergistically with the transgenic plants, in addition to an increased and wider-ranging efficiency of said transgenic plants, thus offering economic and ecological advantages.

### CROSS-REFERENCE TO RELATED APPLICATIONS

This application is a division of U.S. application Ser. No. 10/451,221, filed Sep. 26, 2003, which is the national phase of International Application No. PCT/EP01/14564, filed Dec. 12, 2001, and claiming the priority of Application No. 10065395.2 filed in Germany on Dec. 28, 2000, said applications being incorporated by reference herein their entireties and relied upon.

The invention relates to a method for controlling harmful organisms in crops of Bt maize.

Genetically modified maize plants which express Bacillus thuringiensis (Bt) toxins and are therefore resistant to attack by specific harmful insects (Bt maize) are known and employed increasingly in commercial crop production (see, for example, EP-A 0 485 506). Although existing genetically modified maize has very good characteristics, a series of problems remains so that there is much room for improvement.

It was therefore a further object to provide as effective and environmentally friendly solutions as possible for problems in control of maize pests.

Surprisingly, it has now been found that certain classes of insecticides when used in combination with Bt maize act synergistically.

The invention therefore relates to a method for controlling harmful organisms in genetically modified maize plants containing a gene derives from Bacillus thuringiensis, said gene encoding and expressing a protein with an insecticidal action, wherein an insecticidally active quantity of one or more compounds from the following groups (a) to (f) is applied to the plants, their seeds or propagation material and/or the area in which they are cultivated:

a) insecticidal organophosphorus compounds selected from the group consisting of:

azinphos-ethyl (40), azinphos-methyl (41), cadusafos (101), chlorfenvinphos (124), chlormephos (128), chlorpyrifos (137), diazinon (209), disulfoton (257), ethion (283), ethoprophos (286), etrimfos (295), fonofos (366), isazofos (429), isofenphos (430), methamidophos (479), methidathion (481), monocrotophos (502), phenthoate (565), phorate (570), phosmet (572), phosphamidon (573), phoxim (575), pirimiphosmethyl (585), profenofos (594), prothiofos (614), terbufos (690), tetrachlorvinphos (694) and triazophos (726);

b) pyrethroids selected from the group consisting of:

cypermethrin (183), (alpha)-cypermethrin (184), (beta)-cypermethrin (185), deltamethrin (204), fenvalerate (319), flucythrinate (333), tefluthrin (687) and tralomethrin (718);

c) insecticidal carbamates selected from the group consisting of:

bendiocarb (56), benfuracarb (58), carbaryl (106), carbofuran (109), carbosulfan (110), furathiocarb (376), methiocarb (482), propoxur (610), thiodicarb (708) and trimethacarb (743);

d) biopesticides selected from the group consisting of:

Bacillus thuringiensis (46, 47), granulosis and nuclear polyhedrosis viruses, Beauveria bassiana (52), Beauveria brogniartii (53) and baculoviruses, such as Autographa california;

e) insecticidal growth regulators selected from the group consisting of:

diflubenzuron (231), flufenoxuron (335), lufenuron (446), novaluron (527), methoxyfenozide (643) and tebufenozide (679);

f) others:

bensultap (64), cartap (113), DNOC (261), endosulfan (270), fipronil (323), ethiprole, imidacloprid (418), thiacloprid, phosphine (574), thiocyclam (707), IKI-220, spinosad (754) and thiamethoxam (NEW).

The numbers in brackets are the entry number in ‘The e-Pesticide Manual’, CD-ROM-Version 1.1, 1999-2000 (ISBN: 1-901396-22-3), based on The Pesticide Manual, 11th Edition, British Crop Protection Council, Farnham, 1997.

Baculoviruses are described, for example, in J. Ind. Microbiol. & Biotech 1997, 19, 192. Thiacloprid and IKI-220 are described in, for example, Proceedings of the BCPC-Conference, Pest & Diseases, 2000.

These references and the literature cited therein is herewith expressly referred to; they are incorporated into the description by reference.

The inventive method makes possible a reduced application rate of crop protection products which act synergistically with the transgenic plants, in addition to an increased and wider-ranging efficiency of said transgenic plants, thus offering economic and ecological advantages.

The advantages of the inventive method are firstly synergisms with the Bacillus thuringiensis toxins (Bt toxins) which are produced in the transgenic plant and secondly, for example, reduced number of applications or reduced application rates to in some cases sublethal dosages (in comparison with the conventional use of the individual insecticides), and the markedly reduced pollution of the environment which this entails.

In particular, combinations of the abovementioned active substances, together with the endogenous Bt toxins, i.e. the Bt toxins produced within the transgenic plant, have a pronounced synergistic effect on a multiplicity of harmful organisms to be controlled.

Likewise, the invention relates to the use of compounds from among the abovementioned groups (a) to (f) for controlling harmful organisms in genetically modified maize plants which contain a gene derived from Bacillus thuringiensis which encodes, and expresses, an insecticidally active protein.

For the purposes of the invention, the term “insecticidally active” encompasses an insecticidal, acaricidal, molluscicidal, nematicidal, ovicidal effect and a repellant, behavior—modifying and sterilant effect.

Preferred insecticidal active substances are the organophosphorus compounds, pyrethroids, carbamates, growth regulators, endosulfan, fipronil, ethiprole, imidacloprid, thiamethoxam, thiacloprid, IKI-220 and Bacillus thuringiensis.

Particularly preferred are triazophos, deltamethrin, tebufenozide, endosulfan, fipronil, spinosad and Bacillus thuringiensis.

Also preferred are mixtures of two or more, preferably two or three, particularly preferably two, of the insecticidally active compounds.

Particularly preferred are mixtures of the abovementioned organophosphorus compounds with the abovementioned pyrethroids.

Likewise particularly preferred are the mixtures listed hereinbelow: deltamethrin and endosulfan, deltamethrin and spinosad, deltamethrin and chlorphenapyr, deltamethrin and Bacillus thuringiensis, deltamethrin and methoxyfenozide, deltamethrin and tebufenozide, endosulfan and amitraz, endosulfan and Bacillus thuringiensis, cyfluthrin and chlorpyriphos.

Likewise preferred are mixtures of the abovementioned pyrethroids with imidacloprid, and mixtures of the abovementioned pyrethroids with tebufenozide.

The insecticidally active compounds employed in accordance with the invention are known; most of them are commercially available.

The insecticides used in accordance with the invention are usually obtainable as commercial formulations; however, they can be formulated in various ways, if appropriate, depending on the prevailing biological and/or chemico-physical parameters. The following are examples of possible formulations:

wettable powders (WP), emulsifiable concentrates (EC), aqueous solutions (SL), emulsions, sprayable solutions, oil- or water-based dispersions (SC), suspoemulsions (SE), dusts (DP), seed-dressing materials, granules in the form of microgranules, spray granules, coated granules and adsorption granules, water-dispersible granules (WG), ULV formulations, microcapsules, waxes or baits.

These individual formulation types are known in principle and are described, for example, in:

Winnacker-Küchler, “Chemische Technologie” [Chemical Technology], Volume 7, C. Hauser Verlag Munich, 4th Ed. 1986; van Falkenberg, “Pesticides Formulations”, Marcel Dekker N.Y., 2nd Ed. 1972-73; K. Martens, “Spray Drying Handbook”, 3rd Ed. 1979, G. Goodwin Ltd. London.

The formulation auxiliaries required, such as inert materials, surfactants, solvents and further additives, are likewise known and are described, for example, in:

Watkins, “Handbook of Insecticide Dust Diluents and Garriers”, 2nd Ed., Darland Books, Caldwell N.J.; H. v. Olphen, “Introduction to Clay Colloid Chemistry”, 2nd Ed., J. Wiley & Sons, N.Y.; Marsden, “Solvents Guide”, 2nd Ed., lnterscience, N.Y. 1950; McCutcheon's, “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzfläcchenaktive Äthylenoxidaddukte” [Interface-active ethylene oxide adducts], Wiss. Verlagsgesell., Stuttgart 1967; Winnacker-Küchler, “Chemische Technologie”, Volume 7, C. Hanser Verlag Munich, 4th Ed. 1986.

These references, and the literature cited therein, are expressly referred to; they are incorporated into the description by reference.

Combinations with other pesticidally active materials, fertilizers and/or plant growth regulators may also be prepared on the basis of these formulations, for example in the form of a readymix or a tankmix. Wettable powders are preparations which are uniformly dispersible in water and which, in addition to the active substance, also contain wetters, for example polyoxyethylated alkylphenols, polyoxyethylated fatty alcohols, alkylsulfonates or alkylphenolsulfonates and dispersants, for example sodium lignosulfonate, sodium 2,2′-dinaphthylmethane-6,6′-disulfonate, in addition to a diluent or inert substance.

Emulsifiable concentrates are prepared by dissolving the active substance in an organic solvent, for example butanol, cyclohexanone, dimethylformamide, xylene or else higher-boiling aromatics or hydrocarbons with addition of one or more emulsifiers. Emulsifiers which can be used are, for example, calcium alkylarylsulfonates such as calcium dodecylbenzenesulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxyethylene sorbitol esters.

Dusts are obtained by grinding the active substance with finely divided solid materials, for example talc, natural clays such as kaolin, bentonite and pyrophillite or diatomaceous earth. Granules can be prepared either by spraying adsorptive granulated inert material with the active substance or by applying active substance concentrates to the surface of carriers such as sand, kaolinites or granulated inert material with the aid of binders, for example polyvinyl alcohol, sodium polyacrylate or else mineral oils. Suitable active substances can also be granulated in the fashion which is customary for the production of fertilizer granules, if desired as a mixture with fertilizers.

The active substance concentration in wettable powders is, for example, approximately 10 to 90% by weight, the remainder to 100% by weight being composed of customary formulation constituents. In the case of emulsifiable concentrates, the active substance concentration can amount to approximately 5 to 80% by weight. Formulations in the form of dusts usually contain 5 to 20% by weight of active substance, while sprayable solutions contain approximately 2 to 20% by weight of active substance. In the case of granules, the active substance content depends partly on whether the active compound is in liquid or solid form and on the granulation auxiliaries, fillers and the like which are being used.

In addition, the abovementioned active substance formulations contain, if appropriate, the auxiliaries which are conventional in each case, such as stickers, wetters, dispersants, emulsifiers, penetrants, solvents, fillers or carriers.

For use, the concentrates, which are present in commercially available from, are, if appropriate, diluted in the customary fashion, for example using water in the case of wettable powders, emulsifiable concentrates, dispersions and in some cases also in the case of microgranules. Preparations in the form of dusts, granulated preparations and sprayable solutions are usually not diluted any further with other inert substances prior to use.

The application rate required varies depending on the external conditions such as temperature, humidity and the like. It can vary within wide limits, for example between 0.1 g/ha and 5.0 kg/ha or more of active substances,. However, it is preferably between 0.1 g/ha and 1.0 kg/ha. Owing to the synergistic effects between Bt maize and insecticide, application rates of from 0.5 to 500 g/ha are particularly preferred.

In the case of insecticidal organophosphorus compounds (a) preferred application rates are 50 to 500 g/ha, particularly preferred application rates 50 to 200 g/ha.

In the case of pyrethroids (b), preferred application rates are 0.1 to 10 g/ha, particularly preferred are 0.1 to 6.0 g/ha.

In the case of insecticidal carbamates (c) preferred application rates are 50 to 5 000 g/ha, particularly preferred are 50 to 2 000 g/ha.

In the case of biopesticides (d), the commercially customary application rates are preferred.

In the case of insecticidal growth regulators (e), application rates of 10 to 1 000 g/ha are preferred, particularly preferred are 50 to 500 g/ha.

In the case of the insecticides of group (f), application rates of 0.1 to 5 000 g/ha are preferred, 0.1 to 300 g/ha are particularly preferred.

The active substances according to the invention, in their commercially available formulations and in the use forms prepared from these formulations, may be present in the form of mixtures with other active substances, such as insecticides, attractants, sterilants, acaricides, nematicides, fungicides, growth-regulatory substances or herbicides.

Preferred other components in the mixtures are

1. from the group of the carboxylic esters, acrinathrin, allethrin, alphametrin, 5-benzyl-3-furylmethyl-(E)-, (1R)-cis-2,2-dimethyl-3-(2-oxothiolan-3-ylidenemethyl)cyclopropanecarboxylate, beta-cyfluthrin, bioallethrin, bioallethrin ((S)-cyclopentyl isomer), bioresmethrin, bifenthrin, (RS)-1-cyano-1-(6-phenoxy-2-pyridyl)methyl(1RS)-trans-3-(4-tert-butylphenyl)-2,2-dimethylcyclopropanecarboxylate (NCI 85193), cycloprothrin, cythithrin, cyphenothrin, empenthrin, esfenvalerate, fenfluthrin, flumethrin, fluvalinate (D isomer), imiprothrin (S-41311), permethrin, phenothrin ((R) isomer), prallethrin, pyrethrine (natural products), resmethrin, tetramethrin, theta-cypermethrin (TD-2344), transfluthrin, zeta-cypermethrin (F-56701);

2. from the group of the amidines, chlordimeform;

3. others: ABG-9008, acetamiprid, Anagrapha falcitera, AKD-1022, AKD-3059, ANS-118, bifenazate (D-2341), binapacryl, BJL-932, bromopropylate, BTG-504, BTG-505, buprofezin, camphechlor, chlorobenzilate, chlorfluazuron, 2-(4-chlorophenyl)-4,5-diphenylthiophene (UBI-T930), chlorfentezine, chromafenozide (ANS-118), CG-216, CG-217, CG-234, A-184699, 2-naphthylmethyl cyclopropanecarboxylate (Ro12-0470), cyromazin, diacloden (thiamethoxam), ethyl N-(3,5-dichloro-4-(1,1,2,3,3,3-hexafluoro-1-propyloxy)phenyl)carbamoyl)-2-chlorobenzocarboximidate, DDT, dicofol, N-(2,3-dihydro-3-methyl-1,3-thiazol-2-ylidene)-2,4-xylidine, dinobuton, dinocap, diofenolan, DPX-062, emamectin benzoate (MK-244), ethiprole (sulfethiprole), ethofenprox, etoxazole (YI-5301), fenoxycarb, fluazuron, flumite (flufenzine, SZI-121), 2-fluoro-5-(4-(4-ethoxyphenyl)-4-methyl-1-pentyl)diphenyl ether (MTI 800), fenpyroximate, fenthiocarb, flubenzimine, flucycloxuron, flufenprox (ICI-A5683), fluproxyfen, gamma-HCH, halofenozide (RH-0345), halofenprox (MTI-732), hexaflumuron (DE_{—}473), hexythiazox, HOI-9004, hydramethylnon (AC 217300), indoxacarb (DPX-MP062), kanemite (AKD-2023), M-020, MTI-446, ivermectin, M-020, milbemectin, NC-196, Neemgard, nitenpyram (TI-304), 2-nitromethyl-4,5-dihydro-6H-thiazine (DS 52618), 2-nitromethyl-3,4-dihydrothiazole (SD 35651), 2-nitromethylene-1,2-thiazinan-3-ylcarbamaldehyde (WL 108477), pyriproxyfen (S-71639), NC-196, NC-1111, NNI-9768, OK-9701, OK-9601, OK-9602, propargite, pymethrozine, pyridaben, pyrimidifen (SU-8801), RH-0345, RH-2485, RYI-210, S-1283, S-1833, SB7242, SI-8601, silafluofen, silomadine (CG-177), SU-9118, tebufenpyrad (MK-239), teflubenzuron, tetradifon, tetrasul, TI-435, tolfenpyrad (OMI-88), triflumuron, verbutin, vertalec (mykotal), YI-5301.

The active substance content of the use forms prepared from the commercially available formulations may range from 0.00000001 up to 95% by weight and is preferably between 0.00001 and 1% by weight of active substance.

Accordingly, formulations of mixtures of, for example, pyrethroids and organophosphorus compounds preferably contain 0.05 to 0.01% by weight of pyrethroid and 0.25 to 0.20% by weight of organophosphorus compound, particularly preferably 0.01 to 0.001% by weight of pyrethroid and 0.2 to 0.1% by weight of organophosphorus compound.

In the case of mixtures of pyrethroids and endosulfan, a ratio of 0.05 to 0.01% by weight of pyrethroid to 0.7 to 0.2% by weight of endosulfan is preferred, particularly preferred are 0.01 to 0.001% by weight of pyrethroid and 0.35 to 0.2% by weight of endosulfan.

In the case of mixtures of pyrethroids and Bacillus thuringiensis (Bt), the data given above for pyrethroids apply, while the Bt fraction preferably amounts to 0.01 to 0.001, particularly preferably 0.005 to 0.001% by weight.

Mixtures of endosulfan and amitraz preferably contain 0.35 to 0.2% by weight of endosulfan and 0.6 to 0.2% by weight of amitraz.

The inventive method is preferably suitable for use against all developmental stages of the harmful organisms (egg, all instars such as, for example, L1, L2, L3, L4, to adult), in particular in the control of Homoptera, Diptera, Lepidoptera and Coleoptera.

For the purposes of the invention, the term “Bt maize” is understood as referring to maize plants or maize crops which are genetically modified in such a way that they contain, and express, one or more Bacillus thuringiensis genes which encode an insecticidally active protein.

Preferred are Bacillus thuringiensis crystal proteins from the Cry family (see, for example, N. Crickmore et al., Microbiol. Mol. Biol. Rev. 1998, 62, 807-812), which are active against Lepidoptera, Coleoptera and Diptera.

Particularly preferred are genes encoding the proteins cry1Aa1, cry1Aa2, cry1Aa3, cry1Aa4, cry1Aa5, cry1Aa6, cry1Aa7, cry1Aa8, cry1Aa9, cry1Aa10, cry1Aa11 cry1Ab1, cry1Ab2, cry1Ab3, cry1Ab4, cry1Ab5, cry1Ab6, cry1Ab7, cry1Ab8, cry1Ab9, cry1Ab10, cry1Ab11, cry1Ab12, cry1Ab13, cry1Ab14, cry1Ac1, cry1Ac2, cry1Ac3, cry1Ac4, cry1Ac5, cry1Ac6, cry1Ac7, cry1Ac8, cry1Ac9, cry1Ac10, cry1Ac11, cry1Ac12, cry1Ac13, cry1Ad1, cry1Ad2, cry1Ae1, cry1Af1, cry1Ag1, cry1Ba1, cry1Ba2, cry1Bb1, cry1Bc1, cry1Bd1, cry1Be1, cry1Ca1, cry2Ca2, cry1Ca3, cry1Ca4, cry1Ca5, cry1Ca6, cry1Ca7, cry1Cb1, cry1Cb2, cry1Da1, cry1Da2, cry1Db1, cry1Ea1, cry1Ea2, cry1Ea3, cry1Ea4, cry1Ea5, cry1Ea6, cry1Eb1, cry1Fa1, cry1Fa2, cry1Fb1, cry1Fb2, cry1Fb3, cry1Fb4, cry1Ga1, cry1Ga2, cry1Gb1, cry1Gb2, cry1Ha1, cry1Hb1, cry1la1, cry1la2, cry1la3, cry1la4, cry1la5, cry1la6, cry1lb1, cry1lc2, cry1ld1, cry1le1, cry1l-like, cry1Ja1, cry1Jb1, cry1Jc1, cry1Ka1, cry1-like, cry2Aa1, cry2Aa2, cry2Aa3, cry2Aa4, cry2Aa5, cry2Aa6, cry2Aa7, cry2Aa8, cry2Aa9, cry2Ab1, cry2Ab2, cry2Ab3, cry2Ac1, cry2Ac2, cry2Ad1, cry3Aa1, cry3Aa2, cry3Aa3, cry3Aa4, cry3Aa5, cry3Aa6, cry3Aa7, cry3Ba1, cry3Ba2, cry3Bb1, cry3Bb2, cry3Bb3, cry3Ca1, cry4Aa1, cry4Aa2, cry4Ba1, cry4Ba2, cry4Ba3, cry4Ba4, cry5Aa1, cry5Ab1, cry5Ac1, cry5Ba1, cry6Aa1, cry6Ba1, cry7Aa1, cry7Ab1, cry7Ab2, cry8Aa1, cry8Ba1, cry8Ca1, cry9Aa1, cry9Aa2, cry9Ba1, cry9Ca1, cry9Da1, cry9Da2, cry9Ea1, cry9 like, cry10Aa1, cry10Aa2, cry11Aa1, cry11Aa2, cry11Ba1, cry11Bb1, cry12Aa1, cry13Aa1, cry14Aa1, cry15Aa1, cry16Aa1, cry17Aa1, cry18Aa1, cry18Ba1, cry18Ca1, cry19Aa1, cry19Ba1, cry20Aa1, cry21Aa1, cry21Aa2, cry22Aa1, cry23Aa1, cry24Aa1, cry25Aa1, cry26Aa1, cry27Aa1, cry28Aa1, cry28Aa2, cry29Aa1, cry30Aa1, cry31Aa1, cyt1Aa1, cyt1Aa2, cyt1Aa3, cyt1Aa4, cyt1Ab1, cyt1Ba1, cyt2Aa1, cyt2Ba1, cyt2Ba2, cyt2Ba3, cyt2Ba4, cyt2Ba5, cyt2Ba6, cyt2Ba7, cyt2Ba8, cyt2Bb1.

Particularly preferred are the subfamilies cry1, cry2, cry3, cry5 and cry9.

Very particularly preferred are the subfamilies cry1Ab, cry1Ac and cry9C.

Moreover, it is preferred to employ plants which contain genes for more than one Bt protein.

In addition to the expression of Bacillus thuringiensis (Bt) toxins for insect resistance, the transgenic crop plants may also have a further transgenic characteristic, for example further insect resistances (for example owing to the expression of a protease or peptidase inhibitor, cf. WO-A-95/35031), herbicide resistances (for example against glufosinate or glyphosate owing to expression of the pat or bar gene) or else resistances to nematodes, fungi or viruses (for example owing to the expression of a glucanase, chitinase), or else be genetically modified in their metabolic characteristics so that a qualitative and/or quantitative modification of constituents results (for example owing to modification of the energy, carbohydrate, fatty acid or nitrogen metabolism or metabolite fluxes which influence them). Examples of preferred Bt maize plants are those which additionally have a glufosinate or glyphosate resistance.

Bt maize is known and, including methods for its generation, described extensively in, for example, lshida, Y., Saito, H., Ohta, S., Hiei, Y., Komari, T., and Kumashiro, T. (1996). High efficiency transformation of maize (Zea mayz L.) mediated by Agrobacterium tumefaciens. Nature Biotechnology 4: 745-750.

Moreover, Bt maize is available commercially in various variations, for example under the following names (company/companies in each case in brackets): KnockOut® (Novartis Seeds), NaturGard® (Mycogen Seeds), Yieldgard® (Novartis Seeds, Monsanto, Cargill, Golden Harvest, Pioneer, DeKalb and others), Bt-Xtra® (DeKalb) and StarLink® (Aventis CropScience, Garst and others).

The following types of Bt maize are preferred for the inventive method: KnockOut®, NaturGard®, Yieldgard®, Bt-Xtra® and StarLink®.

Ways of generating transgenic plants which, in comparison with naturally occurring plants, have modified characteristics consist for example in the use of recombinant methods (see, for example, Willmitzer L., 1993, Transgenic plants, in: Biotechnology, A Multivolume Comprehensive Treatise, Rehm et al. (eds.) Vol. 2, 627-659, VCH Weinheim, Germany; D`Halluin et al., 1992, McCormick et al. Plant Cell Reports, 1986, 5, 81-84, EP-A-0221044, EP-A-0131624).

A large number of molecular biology techniques by means of which novel transgenic plants with modified characteristics can be generated, are known to the skilled worker; see, for example, Sambrook et al., 1989, Molecular Cloning, A Laboratory Manual, 2nd Ed., Cold Spring Harbor Laboratory Press, Cold Spring Harbor, N.Y.; or Winnacker “Gene und Klone” [Genes and clones], VCH Weinheim, 2nd Ed. 1996, or Christou, “Trends in Plant Science” 1 (1996) 423-431).

To carry out such recombinant manipulation, suitable nucleic acid molecules can be introduced into plants or plant cells, for example by means of suitable vectors which allow mutagenesis or a change in the sequence to take place by the recombination of DNA sequences. With the aid of the abovementioned standard methods, it is possible, for example, to carry out base substitutions, to remove part sequences or to add natural or synthetic sequences. Also, it is possible, for example, to replace the naturally occurring genes completely by heterologous or synthetic genes, preferably under the control of a promoter which is active in plant cells (gene replacement). To link the DNA fragments with one another, the fragments can be provided with adapters or linkers.

Plant cells with a reduced activity of a gene product can be obtained, for example, by expressing at least one corresponding antisense RNA, a sense RNA for achieving a cosuppression effect, or the expression of at least one suitably constructed ribozyme which specifically cleaves transcripts of the abovementioned gene product.

To this end, it is possible, on the one hand, to use DNA molecules which encompass all of the coding sequence of a gene product including any flanking sequences which may be present, but also DNA molecules which only encompass portions of the coding sequence, it being necessary for these portions to be so long as to cause an antisense effect in the cells. Another possibility is the use of DNA sequences which have a high degree of homology with the coding sequences of a gene product, but are not completely identical.

When expressing nucleic acid molecules in plants, the protein synthesized may be localized in any desired compartment of the plant cell. However, to achieve localization in a particular compartment, the coding region can, for example, be linked to DNA sequences which ensure localization in a particular compartment or at a particular point in time (induced at a particular stage, or chemically or biologically induced; for example transit or signal peptides, timing- or location-specific promoters). Such sequences are known to the skilled worker (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give intact plants.

In this manner, transgenic plants can be obtained which exhibit modified characteristics owing to the overexpression, suppression or inhibition of homologous (i.e. endogenous) genes or gene sequences or the expression of heterologous i.e. exogenous) gene or gene sequences.

The inventive method is suitable for controlling a multiplicity of harmful organisms which are found in particular in maize, in particular insects, arachnids and helminths, very particularly preferably insects and arachnids. The abovementioned pests include:

From the order of the Acarina, for example, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Eotetranychus spp., Oligonychus spp., Eutetranychus spp.

From the order of the Isopoda, for example, Oniscus asselus, Armadium vulgare, Porcellio scaber.

From the order of the Diplopoda, for example, Blaniulus guttulatus.

From the order of the Chilopoda, for example, Geophilus carpophagus, Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Blatta orientalis, Periplaneta americana, Leucophaea madeirae, Blattella germanica, Acheta domesticus, Gryllotalpa spp., Locusta migratoria migratorioides, Melanoplus differentialis, Schistocerca gregaria.

Aus der Ordnung des Isoptera, for example, Reticulitermes spp.

From the order of the Anoplura, for example, Phylloera vastatrix, Pemphigus spp., Pediculus humanus corporis, Haematopinus spp., Linognathus spp.

From the order of the Mallophaga, for example, Trichodectes spp., Damalinea spp.

From the order of the Thysanoptera, for example, Hercinothrips femoralis, Thrips tabaci.

From the order of the Heteroptera, for example, Eurygaster spp., Dysdercus intermedius, Piesma quadrata, Cimex lectularius, Rhodnius prolixus, Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Doralis fabae, Doralis pomi, Eriosoma lanigerum, Hyalopterus arundinis, Macrosiphum avenae, Myzus spp., Phorodon humuli, Rhopalosiphum padi, Empoasca spp., Euscelus bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp.

From the order of the Lepidoptera, for example, Pectinophora gossypiella, Bupalus piniarius, Cheimatobia brumata, Lithocolletis blancardella, Hyponomeuta padella, Plutella maculipennis, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Helicoverpa spp., Laphygma exigua, Mamestra brassicae, Panolis flammea, Prodenia litura, Spodoptera spp., Trichoplusia ni, Carpocapsa pomonella, Pieris spp., Chilo spp., Pyrausta nubilalis, Ephestia kuehniella, Galleria mellonella, Cacoecia podana, Capua reticulana, Choristoneura fumiferana, Clysia ambiguella, Homona magnanima, Tortrix viridana, Ostrinia nubilalis, Bombyx obsoleta.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylloides chrysocephala, Epilachna varivestis, Atomaria spp., Oryzaephilus surinamensis, Anthonumus spp., Sitophilus spp., Otiorrhynchus sulcatus, Cosmopolites sordidus, Ceuthorrynchus assimilis, Hypera postica, Dermestes spp., Trogoderma, Anthrenus spp., Aftagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon soistitialis, Costelytra zealandica.

From the order of the Hymenoptera, for example, Diprion spp., Hoplocampa spp., Lasius spp., Monomorium pharaonis, Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hypobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa.

From the order of the Siphonaptera, for example, Xenopsylla cheopsis, Ceratophyllus spp.

From the order of the Arachnida, for example, Scorpio maurus, Latrodectus mactans.

From the class of the Helminthes, for example, Haemonchus, Trichostrongulus, Ostertagia, Cooperia, Chabertia, Strongyloides, Oesophagostomum, Hyostrongulus, Ancylostoma, Ascaris, Heterakis and Fasciola.

The inventive method is preferably suitable for controlling Heliothis spp., Helicoverpa spp., Prodenia litura, Spodoptera spp., Chilo spp., Ostrinia nubilalis, Bombyx obsoleta and Diabrotica spp.

The invention is illustrated in greater detail by the example which follows, without being limited thereby.

### EXAMPLE

A synergistic effect is demonstrated by 2-week-old Bt maize plants each being sprayed by hand with of the desired active substance (for example triazophos, deltamethrin, tebufenozide, endosulfan, fipronil and Bacillus thuringiensis) at dosages which are below the recommended dosages. The spray volume corresponds to 400 l/ha. After the plants have dried, they are populated with eggs of the European corn borer Ostrinia nubilalis, which attacks the maize stems (the eggs being 2 to 3 days old). The plants are grown in the greenhouse at 23° C. The evaluation for damage caused by attack takes place four weeks after the spray application.

What is claimed is:

1. A method for controlling harmful organisms in genetically modified maize plants containing a gene derived from Bacillus thuringiensis, said gene encoding and expressing a protein with an insecticidal action, said method comprising applying an insecticidally synergistically active quantity of at least one compound selected from the following groups (a) to (f) to the plants, their seeds or propagation material and/or to the area in which they are cultivated:
a) insecticidal organophosphorus compounds selected from the group consisting of:
azinphos-ethyl, azinphos-methyl, cadusafos, chlorfenvinphos, chlormephos, chlorpyrifos, diazinon, disulfoton, ethion, ethoprophos, etrimfos, fonofos, isazofos, isofenphos, methamidophos, methidathion, monocrotophos, phenthoate, phorate, phosmet, phosphamidon, phoxim, pirimiphos-methyl, prothiofos, terbufos, tetrachlorvinphos and triazophos;
b) pyrethroids selected from the group consisting of:
cypermethrin, (alpha)-cypermethrin, (beta)-cypermethrin, deltamethrin, fenvalerate, flucythrinate, tefluthrin and tralomethrin;
c) insecticidal carbamates selected from the group consisting of:
bendiocarb, benfuracarb, carbaryl, carbofuran, carbosulfan, furathiocarb, methiocarb, propoxur, thiodicarb and trimethacarb;
d) biopesticides selected from the group consisting of:
Bacillus thuringiensis, granulosis and nuclear polyhedrosis viruses, Beauveria bassiana, Beauveria brogniartii and baculoviruses;
e) insecticidal growth regulators selected from the group consisting of:
diflubenzuron, flufenoxuron, novaluron, methoxyfenozide and tebufenozide;
f) insecticidal compounds selected from the group consisting of:
bensultap, cartap, DNOC, endosulfan, fipronil, ethiprole, imidacloprid, phosphine, thiocyclam, IKI-220, spinosad and thiamethoxam.

2. The method as claimed in claim 1, wherein said at least one compound is selected from the group consisting of the insecticidal organophosphorus compounds (a), the pyrethroids (b), the insecticidal carbamates (c), the insecticidal growth regulators (e), and the compounds endosulfan, fipronil, ethiprole, imidacloprid, thiamethoxam, thiacloprid, IKI-220 and Bacillus thuringiensis.

3. The method as claimed in claim 1, wherein said at least one compound is selected from the group consisting of triazophos, deltamethrin, tebufenozide, endosulfan, fipronil, spinosad and Bacillus thuringiensis.

4. The method as claimed in claim 1, wherein a mixture of at least two of the insecticidally active compounds is applied.

5. The method as claimed in claim 1, wherein the insecticidally active compound is applied at an application rate of from 0.0001 to 5.0 kg/ha.

6. The method as claimed in claim 1, wherein the at least one insecticidal compound is applied as a 0.00001 to 95% by weight formulation.

7. The method as claimed in claim 1, wherein the insecticidally active protein in the maize plant is a crystal protein from at least one subfamily selected from the group consisting of cry1, cry2, cry3, cry5 and cry9.

8. The method as claimed in claim 1, wherein the maize plants have a glufosinate or glyphosate resistance.

9. The method as claimed in claim 1, wherein the harmful organisms are insects which belong to an order selected from the group consisting of Homoptera, Lepidoptera and Coleoptera.

10. The method as claimed in claim 1, wherein the at least one insecticidally active compound is applied to control all developmental stages of the harmful organisms.

11. The method as claimed in claim 1, wherein the insecticidally active compound is applied to control harmful organisms selected from the group consisting of adults, eggs and larvae, the larvae being selected from those in the L1, L2, L3 and L4 instars.

12. The method as claimed in claim 1, wherein, in addition to at least one insecticidally active compound selected from groups (a) to (f), at least one further insecticidally, fungicidally or herbicidally active compound is applied.

13. The method as claimed in claim 7, wherein the insecticidally active protein in the maize plant is selected from the group consisting of cry1Ab, cry1Ac and cry9C.

14. The method as claimed in claim 2, wherein a mixture of at least two of the insecticidally active compounds is applied.

15. The method as claimed in claim 3, wherein a mixture of at least two of the insecticidally active compounds is applied.

16. The method as claimed in claim 2, wherein the at least one insecticidally active compound is applied at an application rate of from 0.0001 to 5.0 kg/ha.

17. The method as claimed in claim 3, wherein the at least one insecticidally active compound is applied at an application rate of from 0.0001 to 5.0 kg/ha.

18. The method as claimed in claim 4, wherein the mixture is applied at an application rate of from 0.0001 to 5.0 kg/ha.

19. The method as claimed in claim 14, wherein the mixture is applied at an application rate of from 0.0001 to 5.0 kg/ha.

20. The method as claimed in claim 15, wherein the mixture is applied at an application rate of from 0.0001 to 5.0 kg/ha.

21. The method as claimed in claim 2, wherein the at least one insecticidal compound is applied as a 0.00001 to 95% by weight formulation.

22. The method as claimed in claim 3, wherein the at least one insecticidal compound is applied as a 0.00001 to 95% by weight formulation.

23. The method as claimed in claim 4, wherein the mixture is applied as a 0.00001 to 95% by weight formulation.

24. The method as claimed in claim 5, wherein the at least one insecticidal compound is applied as a 0.00001 to 95% by weight formulation.

25. The method as claimed in claim 2, wherein the insecticidally active protein in the maize plant is a crystal protein from at least one subfamily selected from the group consisting of cry1, cry2, cry3, cry5 and cry9.

26. The method as claimed in claim 3, wherein the insecticidally active protein in the maize plant is a crystal protein from at least one subfamily selected from the group consisting of cry1, cry2, cry3, cry5 and cry9.

27. The method as claimed in claim 4, wherein the insecticidally active protein in the maize plant is a crystal protein from at least one subfamily selected from the group consisting of cry1, cry2, cry3, cry5 and cry9.

28. The method as claimed in claim 5, wherein the insecticidally active protein in the maize plant is a crystal protein from at least one subfamily selected from the group consisting of cry1, cry2, cry3, cry5 and cry9.

29. The method as claimed in claim 6, wherein the insecticidally active protein in the maize plant is a crystal protein from at least one subfamily selected from the group consisting of cry1, cry2, cry3, cry5 and cry9.

30. The method as claimed in claim 14, wherein the insecticidally active protein in the maize plant is a crystal protein from at least one subfamily selected from the group consisting of cry1, cry2, cry3, cry5 and cry9.

31. The method as claimed in claim 15, wherein the insecticidally active protein in the maize plant is a crystal protein from at least one subfamily selected from the group consisting of cry1, cry2, cry3, cry5 and cry9.

32. The method as claimed in claim 2, wherein the maize plants have a glufosinate or glyphosate resistance.

33. The method as claimed in claim 3, wherein the maize plants have a glufosinate or glyphosate resistance.

34. The method as claimed in claim 4, wherein the maize plants have a glufosinate or glyphosate resistance.

35. The method as claimed in claim 5, wherein the maize plants have a glufosinate or glyphosate resistance.

36. The method as claimed in claim 6, wherein the maize plants have a glufosinate or glyphosate resistance.

37. The method as claimed in claim 7, wherein the maize plants have a glufosinate or glyphosate resistance.

38. The method as claimed in claim 14, wherein the maize plants have a glufosinate or glyphosate resistance.

39. The method as claimed in claim 15, wherein the maize plants have a glufosinate or glyphosate resistance.

40. The method as claimed in claim 25, wherein the insecticidally active protein in the maize plant is selected from the group consisting of cry1Ab, cry1AC and cry9C.

41. The method as claimed in claim 26, wherein the insecticidally active protein in the maize plant is selected from the group consisting of cry1Ab, cry1AC and cry9C.

42. The method as claimed in claim 27, wherein the insecticidally active protein in the maize plant is selected from the group consisting of cry1Ab, cry1AC and cry9C.

43. The method as claimed in claim 28, wherein the insecticidally active protein in the maize plant is selected from the group consisting of cry1Ab, cry1AC and cry9C.

44. The method as claimed in claim 29, wherein the insecticidally active protein in the maize plant is selected from the group consisting of cry1Ab, cry1AC and cry9C.

45. The method as claimed in claim 30, wherein the insecticidally active protein in the maize plant is selected from the group consisting of cry1Ab, cry1AC and cry9C.

46. The method as claimed in claim 31, wherein the insecticidally active protein in the maize plant is selected from the group consisting of cry1Ab, cry1AC and cry9C.

47. A method for controlling insects of an order selected from the group consisting of Homoptera, Lepidoptera and Coleoptera in genetically modified maize plants containing a gene derived from Bacillus thuringiensis, said gene encoding and expressing a protein with an insecticidal action, said protein being selected from the group consisting of cry1Ab, cry1Ac and cry9C, said method comprising applying an insecticidally synergistically active quantity of one or two compounds selected from the group consisting of triazophos, deltamethrin, tebufenozide, endosulfan, fipronil, spinosad and Bacillus thuringiensis to the plants, their seeds or propagation material and/or to the area in which they are cultivated.
